(19) United States
(12) Patent Application Publication
(10) Pub. No.: US 2019/0137975 A1
(43) Pub. Date: May 9, 2019

(54) NUMERICAL CONTROL APPARATUS

(71) Applicant: Mitsubishi Electric Corporation, Tokyo (JP)

(72) Inventors: Kenji Nishiwaki, Tokyo (JP); Shinya Nishino, Tokyo (JP)

(73) Assignee: Mitsubishi Electric Corporation, Tokyo (JP)

(21) Appl. No.: 16/306,119

(22) PCT Filed: Jul. 29, 2016
(86) PCT No.: PCT/JP2016/072349

§ 371 Date: Nov. 30, 2018

(51) Int. Cl. G05B 19/41

(52) U.S. Cl. CPC G05B 19/41; G05B 2219/34083

(57) ABSTRACT

A numerical control apparatus includes a program command shape determining unit that determines a shape of a command path formed by command points on the basis of information on the command points included in a machining program. There is also an insertion point generating unit that generates insertion points on the basis of a result of determination by the program command shape determining unit and the information on the command points. Further, there is an interpolation unit that generates a tool path by performing interpolation on the basis of the insertion points and causes a motor control unit to control a motor on the basis of the tool path.

### FIELD

The present invention relates to a numerical control apparatus for performing numerical control on a machine tool that machines a free-form surface by following a machining program.

### BACKGROUND

A machine tool equipped with a numerical control apparatus can machine a three-dimensional shape by following a machining program that approximates a free-form surface using a plurality of consecutive command paths. The machining program can be created manually if the shape is simple, but in the case of a three-dimensional shape including a free-form surface, the machining program is typically created on an external device separate from the numerical control apparatus by using Computer Aided Manufacturing (CAM). In the machining program created using CAM, a segment length, which is the length of one command path, is short in order for the free-form surface to be represented as accurately as possible. Computer Aided Manufacturing sometimes creates a machining program with a minute gap in the command path due to an arithmetic error.

A minute gap included in the command path of the machining program causes variations in the command points of adjacent paths, such as the forward path and the backward path of a reciprocating machining path. This causes a flaw during machining. When CAM outputs a machining program with a long segment, the command path of a tool moving in a polygonal line closely following the command path of the created machining program is directly transferred to the workpiece. As a result, the desired smooth machined-surface cannot be obtained in some cases.

Consequently, conventional numerical control apparatus uses a smoothing technique to reduce the influence of a noise block such as the minute gap in the command path of the machining program by approximating machining program command points using a Non-Uniform Rational B-Spline (NURBS) curve or the like that is capable of being represented mathematically.

For the purpose of obtaining a smooth machined-surface without a gap between adjacent generated tool paths, Patent Literature 1 sets a plurality of target points at regular intervals on a tool path, calculates an approximate curve on the basis of the plurality of target points that are set, and generates a tool path along the approximate curve.

### CITATION LIST

### Patent Literature

Patent Literature 1: Japanese Patent Application Laid-open No. 2011-96077

### SUMMARY

### Technical Problem

The method disclosed in Patent Literature 1 sets the plurality of target points at regular intervals, meaning the target points are arranged at regular intervals regardless of shapes such as corner portions or arcs in the machining program. The method thus fails to achieve high accuracy at corner portions and fails to smoothly control the tool path in arc portions.

The present invention has been made in view of the above, and an objective of the present invention is to obtain a numerical control apparatus that can perform high-quality machining of a shape while following a machining program.

### Solution to Problem

In order to solve the above problem and achieve the object, the present invention includes a program command shape determining unit that determines, on the basis of information on command points included in a machining program, the shape of a command path formed by the command points; and an insertion point generating unit that generates insertion points on the basis of a result of determination performed by the program command shape determining unit and information on the command points. The present invention further includes an interpolation unit that generates a tool path by performing interpolation on the basis of the insertion points and causes a motor control unit to control a motor in accordance with the tool path.

### Advantageous Effects of Invention

The numerical control apparatus according to the present invention can perform high-quality machining of a shape while following a machining program.

### BRIEF DESCRIPTION OF DRAWINGS

FIG. 1 is a block diagram illustrating an example of the configuration of a numerical control apparatus according to a first embodiment of the present invention.

FIG. 2 is a diagram illustrating an example of machining program command points for a corner shape according to the first embodiment.

FIG. 3 is a diagram illustrating an example of machining program command points for an arc shape according to the first embodiment.

FIG. 4 is a diagram illustrating an example of machining program command points for the corner shape according to the first embodiment.

FIG. 5 is a diagram illustrating another example of machining program command points for the corner shape according to the first embodiment.

FIG. 6 is a diagram illustrating an example of machining program command points for the arc shape according to the first embodiment.

FIG. 7 is a diagram illustrating another example of machining program command points for the arc shape according to the first embodiment.

FIG. 8 is a diagram illustrating an example of machining program command points including a noise block at the corner shape according to the first embodiment.

FIG. 9 is a diagram illustrating an example of machining program command points where adjacent command paths form corner shapes having different angles according to the first embodiment.

FIG. 10 is a diagram illustrating another example of machining program command points for the arc shape according to the first embodiment.

FIG. 11 is a flowchart illustrating a procedure starting with reading a machining program and ending with shape determination according to the first embodiment

FIG. 12 is a diagram illustrating machining program command points for a corner shape according to the first embodiment.

FIG. 13 is a diagram illustrating another set of machining program command points for the corner shape according to the first embodiment.

FIG. 14 is a diagram illustrating an example of insertion points generated for the corner shape according to the first embodiment.

FIG. 15 is a diagram illustrating another example of insertion points generated for the corner shape according to the first embodiment.

FIG. 16 is a diagram illustrating machining program command points for an arc shape according to the first embodiment.

FIG. 17 is a diagram illustrating another set of machining program command points for the arc shape according to the first embodiment.

FIG. 18 is a diagram illustrating an example of insertion points generated for the arc shape according to the first embodiment.

FIG. 19 is a diagram illustrating how linear approximating interpolation is performed on the basis of the insertion points for the corner shape according to the first embodiment.

FIG. 20 is a diagram illustrating how curve approximating interpolation is performed on the basis of the insertion points for the corner shape according to the first embodiment.

FIG. 21 is a flowchart illustrating a procedure starting from the generation of the insertion points and ending with the generation of a tool path according to the first embodiment.

FIG. 22 is a diagram illustrating an example in which a component of the numerical control apparatus according to the first embodiment is implemented by dedicated hardware.

FIG. 23 is a diagram illustrating a hardware configuration when a component of the numerical control apparatus according to the first embodiment is implemented by a computer.

### DESCRIPTION OF EMBODIMENT

A numerical control apparatus according to an embodiment of the present invention will now be described in detail with reference to the drawings. Note that the present invention is not limited to the embodiment.

### First Embodiment

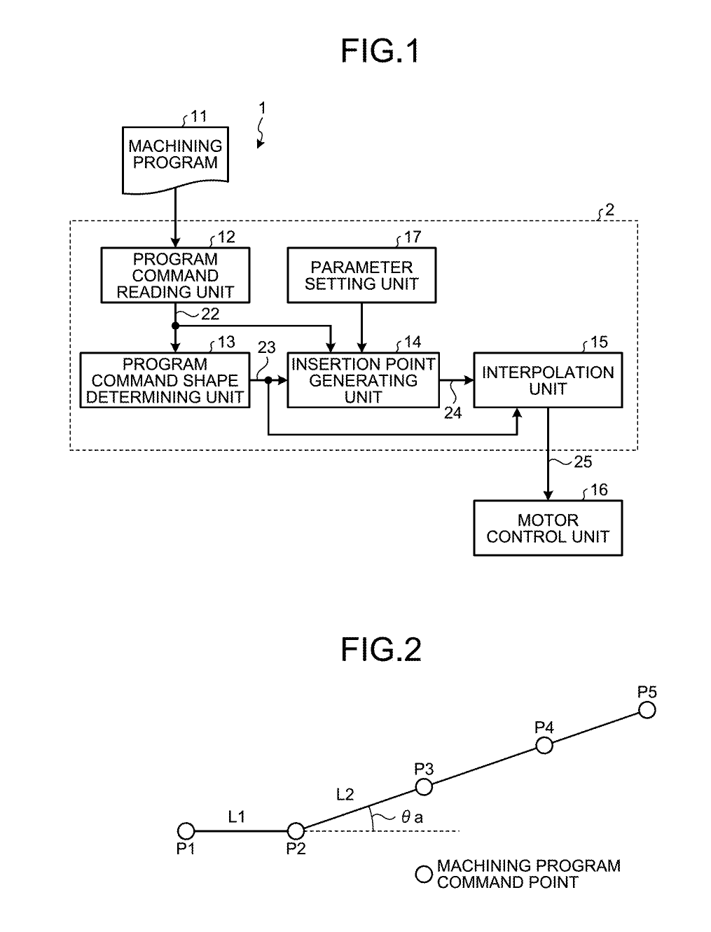

FIG. 1 is a block diagram illustrating an example of a configuration of a numerical control apparatus 2 according to a first embodiment of the present invention. The numerical control apparatus 2 according to the first embodiment is a path controller and is used for an apparatus such as a numerically controlled (NC) machine tool or an industrial robot that operates by following a machining program command. FIG. 1 illustrates an example in which the numerical control apparatus 2 is used in an NC machine tool 1. The numerical control apparatus 2 controls a motor control unit 16 such as a servo amplifier by following a machining program 11 that is input.

As with known G-code data, the machining program 11 includes, for example, a selection signal for a tool to be used; data indicating a path of travel, i.e., a command path, of a tool to be controlled; and data on the travel speed of a tool. The command path is a path formed by command points, and thus the data indicating the command path corresponds to coordinate information on the machining program command points that are the command points. The machining program 11 is generated by CAM on the basis of a three-dimensional design drawing created by Computer-Aided Design (CAD) or the like. When a free curve represented by the above three-dimensional design drawing is taken as a path of travel, CAM divides the free curve into minute sections and replaces curves of the minute sections with line segments, thereby approximating the free curve with a polyline and generating the machining program that outputs the command path in which the free curve is linearly interpolated using the approximated polyline.

As illustrated in FIG. 1, the numerical control apparatus 2 according to the first embodiment includes the following: a program command reading unit 12 that reads information on a machining program command point from the machining program 11 that is input; a program command shape determining unit 13 that determines, on the basis of a machining program command position 22 received from the program command reading unit 12, the shape of the command path that follows the machining instructions; an insertion point generating unit 14 that generates an insertion point on the basis of the result of determination 23 performed by the program command shape determining unit 13 and the machining program command position 22; an interpolation unit 15 that generates a tool path by interpolation on the basis of the insertion point generated by the insertion point generating unit 14 and outputs the travel of a tool for every interpolation cycle as a motor command position 25; and a parameter setting unit 17 that sets the tolerance of the insertion point generating unit 14. The machining program command position 22 is information on the machining program command point. The tool path is the command path after correction. The interpolation cycle is a fixed cycle defined as a specification of the numerical control apparatus 2. The motor control unit 16 controls a motor on the basis of the tool path obtained by the interpolation unit 15. Specifically, the motor control unit 16 receives the motor command position 25 from the interpolation unit 15, and it controls the current and torque of the motor such that the motor achieves the travel for every interpolation cycle along the tool path. The motor drives a plurality of axes.

The program command shape determining unit 13 determines a program shape on the basis of the command path indicated by the machining program command position 22 received from the program command reading unit 12.

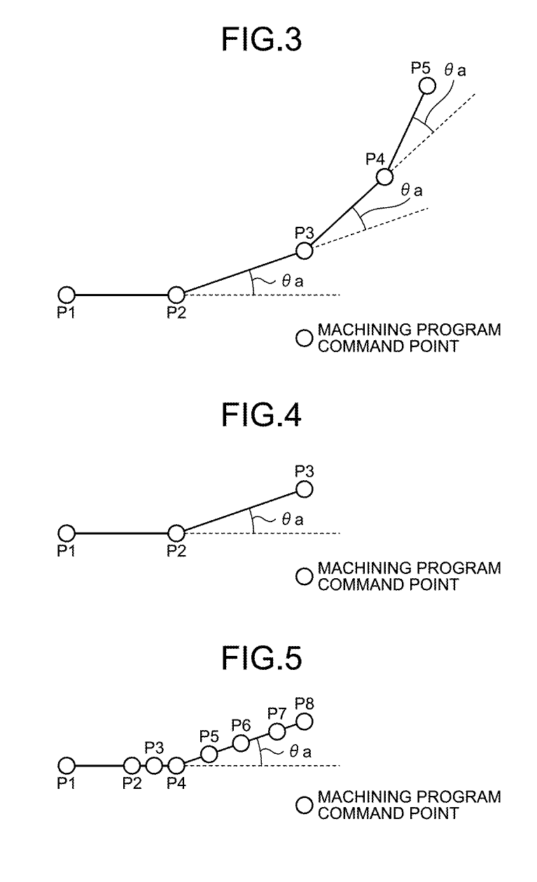

FIG. 2 is a diagram illustrating an example of machining program command points for a corner shape according to the first embodiment. FIG. 3 is a diagram illustrating an example of machining program command points for an arc shape according to the first embodiment.

FIG. 2 illustrates a machining program command made up of five machining program command points P1, P2, P3, P4, and P5 forming an angle θa. The machining program 11 gives instruction for the positioning, i.e., the coordinates, of the machining program command point. The information on the coordinates of the machining program command point is given to the program command shape determining unit 13 as the machining program command position 22. The program command shape determining unit 13 can thus calculate the angle θa indicating the shape of the command path in accordance with instructions from the machining program 11 with the following expression (1). The angle θa is the angle formed by line segments connected to form the command path.

$$\begin{matrix}[ Expression 1 ] & \\ θ a = 2 \times arcsin ( \frac{\sqrt{{Rx}^{2} + {Ry}^{2}}}{2} ) & ( 1 )\end{matrix}$$

In the expression, “Rx” and “Ry” represent an x component and y component of a change in ratio R of the axes driven by the motor, respectively. The change in ratio R of the axes is a change in the ratio of travel in the axes in accordance with instructions from the machining program 11. If (x1, y1) are the coordinates of the point P1, (x2, y2) are the coordinates of the point P2, (x3, y₃) are the coordinates of the point P3, “L1” is the distance between the points P1 and P2, and “L2” is the distance between the points P2 and P3, then “Rx” and “Ry” are expressed by the following expressions (2) and (3).

$$\begin{matrix}[ Expression 2 ] & \\ Rx = \frac{{x}_{3} - {x}_{2}}{L 2} - \frac{{x}_{2} - {x}_{1}}{L 1} & ( 2 ) \\ [ Expression 3 ] & \\ Ry = \frac{{y}_{3} - {y}_{2}}{L 2} - \frac{{y}_{2} - {y}_{1}}{L 1} & ( 3 )\end{matrix}$$

FIG. 3 illustrates a command path approximating an arc shape. Here, the angle formed by line segments at each machining program command point to which the line segments forming the command path are connected is equal to θa for all the machining program command points illustrated in FIG. 3 when calculated according to expression (1), the angle θa being the same angle as the angle θa in FIG. 2. When the shape is determined only by the angle at each command point, the corner shape in FIG. 2 and the arc shape in FIG. 3 are determined to be the same shape. The shape can be determined on the basis of the change in ratio R of the axes in addition to the angle θa formed between the line segments functioning as the commanded path. However, when the change in ratio R of the axes is calculated, the ratio R has the same value between FIG. 2 and FIG. 3.

The method of calculating the clamp speed at a corner is different from The method of calculating the clamp speed in an arc. Thus, in the case where the shapes have the same angle formed between the line segments that are the command path as illustrated in FIG. 2 and FIG. 3, the speed cannot be calculated correctly if processing is performed assuming that the shape is a corner shape when the shape is in fact an arc shape. The inability to calculate the correct speed causes a flaw in the machined surface.

Accordingly, the program command shape determining unit 13 calculates an index value I. The index value I is a change in the change in ratio R of the axes. The program command shape determining unit 13 calculates the index value I and determines the program shape on the basis of the index value I. Here, an example of the index value I will be described. The index value I at a certain machining program command point is an absolute value of the difference between the change in ratio R of the axes at the machining program command point and the change in ratio R of the axes at a next machining program command point, or it is the change in the change in ratio R of the axes. In the case of the corner shape in FIG. 2, the index value I at the point P2 is a change between the change in ratio R at the point P2 and the change in ratio R at the point P3, thereby having a large value at the command point P2. The index value at each of the point P3 and the subsequent points is zero when the points P2 to P5 are linear as illustrated in FIG. 2.

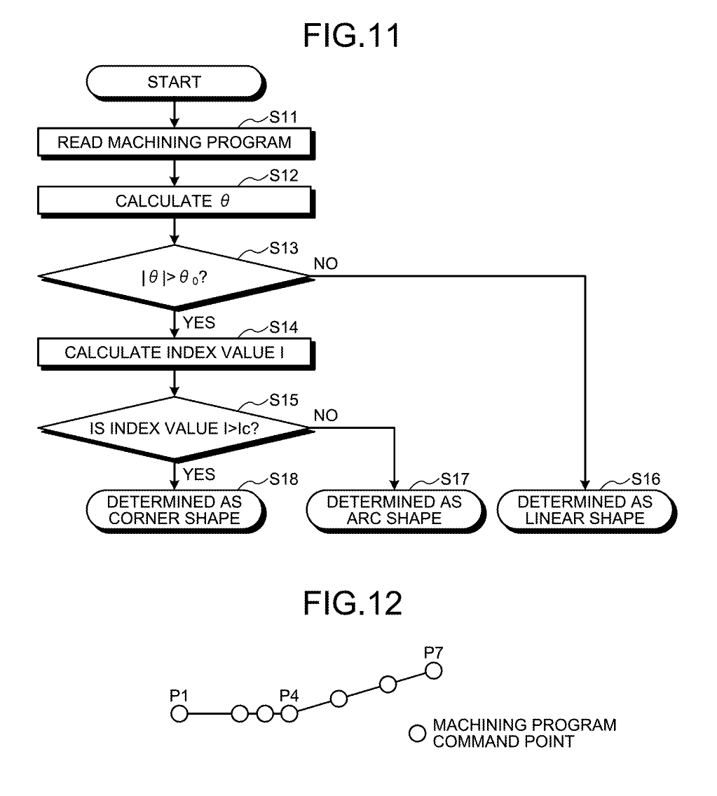

For the arc shape in FIG. 3, the change in ratio R of the axes at each of the point P2 and the subsequent machining program command points is calculated to be the same value. Thus, a change in the change in ratio R of the axes, which is the index value I, is zero at each of the point P2 and the subsequent machining program command Points in FIG. 3. The use of such an index value I allows the program command shape determining unit 13 to determine the shape given by the program command. That is, as illustrated in the flowchart of FIG. 11 (described later), the shape is determined to be a corner shape when the change in ratio R of the axes is non-zero and the change in the change in ratio R of the axes is larger than a predetermined value, and it is determined to be an arc shape when the change in ratio R of the axes is non-zero and the change in the change in ratio R of the axes is smaller than a predetermined value. When the change in ratio R of the axes is zero, i.e., when the angle formed between the line segments that form the command path is 0°, the shape can be determined to be a straight line.

The program command shape determining unit 13 of the first embodiment calculates the angle θa formed between the line segments connected as the command path on the basis of the change in ratio R of the axes, and it calculates the index value I as the change in the change in ratio R of the axes. However, the index value I can be a change in curvature or a change in speed, i.e., acceleration. The change in ratio R of the axes, the curvature, and the speed are each a numerical value calculated for every machining program command point on the basis of information on a plurality of machining program command points including the machining program command point concerned. The index value I can thus be a change in a numerical value calculated on the basis of the information on the plurality of machining program command points.

FIG. 4 is a diagram illustrating an example of machining program command points for a corner shape according to the first embodiment. FIG. 5 is a diagram illustrating another example of machining program command points for the corner shape according to the first embodiment.

In a case where the shape of the command path in accordance with instructions from the machining program 11 is a corner shape with the angle θa formed between the line segments on either side of the command point and functioning as the command path, the index value I for the corner shape in the first embodiment can be calculated only at each of three, simple machining program command points P1, P2, and P3 forming the angle θa, as illustrated in FIG. 4. However, unlike FIG. 4, the index value I can be calculated at a command point that is a joint between line segments obtained by dividing the command path into shorter line segments as illustrated in FIG. 5. The command points illustrated in FIG. 5 are spaced not evenly but unevenly. Even when the command points are set as illustrated in FIG. 5, the index value I is large only at the point P4 corresponding to the corner. The index value I at the point P2 in FIG. 4 is the same as the index value I at the point P4 in FIG. 5; consequently, the program command shape determining unit 13 can determine the shapes to be similar.

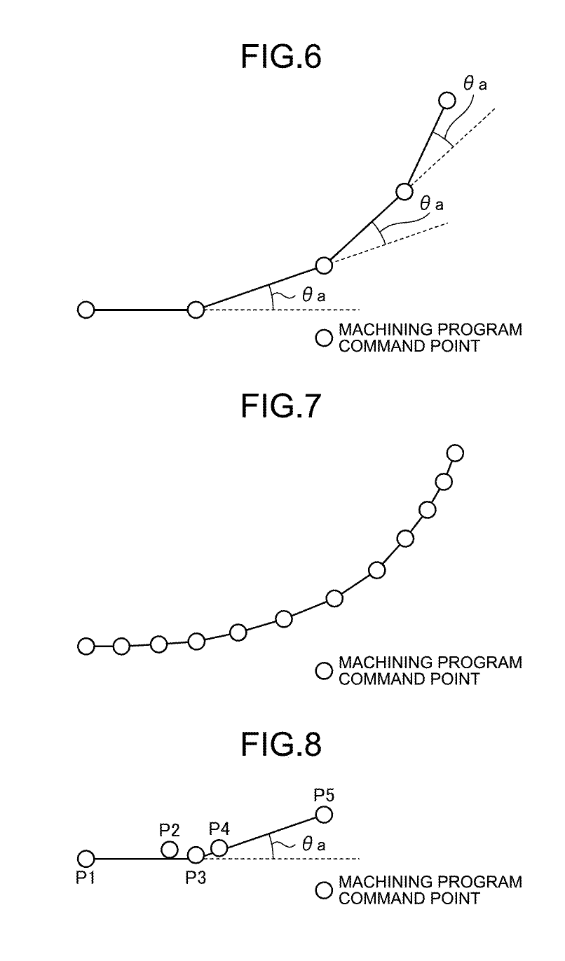

FIG. 6 is a diagram illustrating an example of machining program command points for an arc shape according to the first embodiment. FIG. 7 is a diagram illustrating another example of machining program command points for the arc shape according to the first embodiment.

In a case where the shape of the command path in accordance with instructions from the machining program 11 is an arc shape, the index values I calculated in the cases of FIGS. 6 and 7 are smaller than those calculated in the cases of FIGS. 4 and 5. In FIG. 6, the index value I is calculated at a command point that is a joint between command paths with long segment lengths, and in FIG. 7, the index value I is calculated at each of the command points, which are set at shorter intervals than the command points in FIG. 6. The program command shape determining unit 13 can thus determine that the shapes are both arc shapes in the cases of FIGS. 6 and 7.

The angle formed by the command points P1, P2, and P3 in FIG. 4 is the same as the angle formed by the command points P1, P4, and P8 in FIG. 5. In the cases of FIGS. 4 and 5 where the command points do not include a noise block that is a command point including an error, the index value I at the point P2 in FIG. 4 is equal to the index value I at the point P4 in FIG. 5 when the index value I is calculated using the change in ratio R of the axes that is calculated as expressed in expressions (2) and (3) using three consecutive command points. In a case where the command points include a noise block, however, an error occurs in the calculation of the change in ratio R of the axes using three consecutive command points.

FIG. 8 is a diagram illustrating an example of machining program command points including a noise block for a corner shape according to the first embodiment. The machining program command points can include points P2 and P4 as noise blocks as illustrated in FIG. 8. To take such a situation into consideration, the program command reading unit 12 reads the machining program 11 ahead and globally calculates the change in ratio R of the axes at the machining program command points. Globally calculating the change in ratio R of the axes at the machining program command points means calculating the change in ratio R of the axes using not only local information such as information on the machining program command point concerned and machining program command points around the machining program command point concerned, but also information on other machining program command points that are farther away.

A specific method of globally calculating the change in ratio R of the axes will be described using the point P3 in FIG. 8 as an example. As an example of the method of globally calculating the change in ratio R of the axes, the change in ratio R of the axes at the point P3 is calculated by calculating the change in ratio R using the coordinates of the points P1, P3, and P5 while omitting the command points P2 and P4 which are the noise blocks preceding and following the point P3. As another method, an average of the change in ratio R of the axes calculated using the points P2, P3, and P4 and the change in ratio R of the axes calculated using the points P1, P3, and P5 is obtained as a final change in ratio R of the axes at the point P3. However, the method of globally calculating the change in ratio R is not limited thereto. The change in ratio R at the point P3 calculated without the points P2 and P4 being the noise blocks in FIG. 8 has the same value as the change in ratio R at the point P2 in FIG. 4.

Globally calculating the change in ratio R of the axes at each command point as in the above example means globally calculating the index value I that is the absolute value of the difference between the changes in ratio R of the axes at the command points that are arranged consecutively. As a result, the index value I at the point P3 in FIG. 8 has the same or substantially the same value as the index value I at the point P2 in FIG. 4. The shapes of FIGS. 4 and 8 are thus similarly determined to be a corner shape. As a result, even when a noise block is included in either or both of adjacent command paths subjected to reciprocating machining, the command paths can be determined to be the same shape with being affected by the noise block. A smooth machined-surface can thus be obtained without causing a gap between the adjacent command paths.

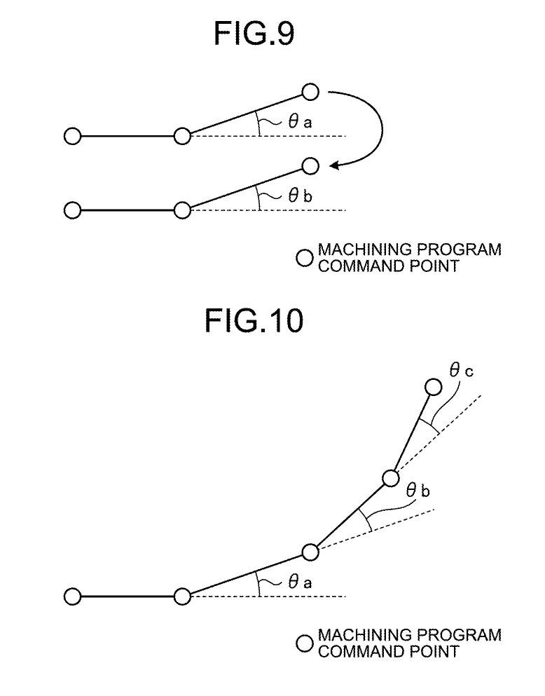

FIG. 9 is a diagram illustrating an example of machining program command points with which adjacent command paths form corner shapes having different angles according to the first embodiment. FIG. 9 illustrates the machining program command points of the adjacent command paths subjected to reciprocating scan machining. The angle formed by the upper command path in FIG. 9 is indicated as “θa”, and the angle formed by the lower command path is indicated as “θb”, which is different from “θa”. Even in the case of the command paths as in FIG. 9, the change in ratio R of the axes and the index value I can be obtained at a point of change in the angle on each path. When the change in ratio R of the axes is obtained, the angle is also obtained from expression (1) so that the program command shape determining unit 13 can determine, on the basis of the index value I, that the upper command path in FIG. 9 has a corner shape with the angle θa and the lower commanded path in FIG. 9 has a corner shape with the angle θb.

FIG. 10 is a diagram illustrating yet another example of machining program command points for the arc shape according to the first embodiment. FIG. 10 illustrates the arc shape in which the angles θa, θb, and θc formed by the command path at the machining program command points are different from one another. When the angles θa, θb, and θc are not substantially different from one another, the index value I at each command point has a small value close to zero. As a result, even when the angles formed by the command path at the command points are different as illustrated in FIG. 10, the program command shape determining unit 13 can determine that the command path has an arc shape.

FIG. 11 is a flowchart illustrating a procedure starting with reading a machining program and ending with shape determination according to the first embodiment.

First, the program command reading unit 12 reads the machining program 11 (step S11). Next, on the basis of the machining program 11 being read, the program command shape determining unit 13 calculates an angle θ formed by a command path at a machining program command point (step S12). In order to calculate the angle θ formed by the command path at the command point, a change in ratio R of the axes at the commanded point needs to be calculated. Here, the change in ratio R can be calculated globally as described above.

The program command shape determining unit 13 then determines whether an absolute value |θ| of the angle θ calculated in step S12 is larger than a predetermined angle θ0 (|θ|>θ0) (step S13). If the absolute value |θ| is not larger than the angle θ0 (No in step S13), the program command shape determining unit 13 determines that the command path has a linear shape (step S16). If the absolute value |θ| is larger than the angle θ₀ (Yes in step S13), the program command shape determining unit 13 calculates an index value I (step S14).

After step S14, the program command shape determining unit 13 determines whether the index value I is larger than a predetermined value Ic (I>Ic) (step S15). If the index value I is not larger than the predetermined value Ic (No in step S15), the program command shape determining unit 13 determines that the command path has an arc shape (step S17). If the index value I is larger than the predetermined value Ic (Yes in step S15), the program command shape determining unit 13 determines that the command path has a corner shape (step S18).

The insertion point generating unit 14 generates an insertion point on the basis of the result of determination 23 of the shape of the command path by the program command shape determining unit 13 and the machining program command position 22 received from the program command reading unit 12. The insertion point is a reference point for interpolating the command path in order to generate a tool path.

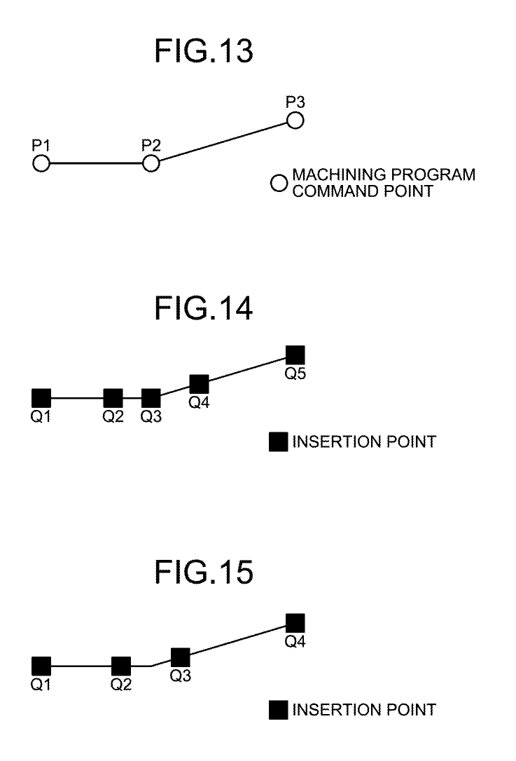

FIG. 12 is a diagram illustrating machining program command points for a corner shape according to the first embodiment. FIG. 13 is a diagram illustrating another set of machining program command points for the corner shape according to the first embodiment. FIGS. 12 and 13 illustrate the machining program command points on the command path of the same corner shape.

FIG. 14 is a diagram illustrating an example of insertion points generated for the corner shape according to the first embodiment. FIG. 14 illustrates the arrangement of insertion points Q1, Q2, Q3, Q4, and Q5 generated by the insertion point generating unit 14 on the command path of FIGS. 12 and 13 determined to have a corner shape.

The command path is determined to have a corner shape on the basis of the index value I at the machining program command point P4 in FIG. 12 or the index value I at the machining program command point P2 in FIG. 13 so that, in FIG. 14, the insertion point Q3 is placed at a point corresponding to the point P4 in FIG. 12 or the point P2 in FIG. 13, and the insertion points Q2 and Q4 are further arranged at points that are equidistant from the point P4 in FIG. 12 or the point P2 in FIG. 13. This can increase the machining accuracy at the corner portion through interpolation to be described later. FIGS. 12 and 13 illustrate the machining program command points connecting the command paths of straight lines having different segment lengths such that the command paths form a corner shape. However, the index value I at the point P4 in FIG. 12 and the index value I at the point P2 in FIG. 13 are calculated to be the same value by the program command shape determining unit 13 without being affected by the segment length for the command path indicated by the machining program 11 and the noise block included in the machining program 11, whereby the insertion points can be properly arranged irrespective of the segment length and the noise block.

FIG. 15 is a diagram illustrating another example of insertion points generated for the corner shape according to the first embodiment. FIG. 15 illustrates the arrangement of insertion points Q1, Q2, Q3, and Q4 generated by the insertion point generating unit 14 on the command path of FIGS. 12 and 13 determined to have a corner shape.

The command path is determined to have a corner shape on the basis of the index value I at the machining program command point P4 in FIG. 12 or the index value I at the machining program command point P2 in FIG. 13 so that in FIG. 15, as with FIG. 14, the insertion points Q2 and Q3 are placed at the points that are equidistant from the point P4 in FIG. 12 or the point P2 in FIG. 13, but no insertion point is placed at the point corresponding to the point P4 in FIG. 12 or the point P2 in FIG. 13. The insertion point need not necessarily be arranged at the machining program command point at which the index value I is calculated for determining that the command path has a corner shape.

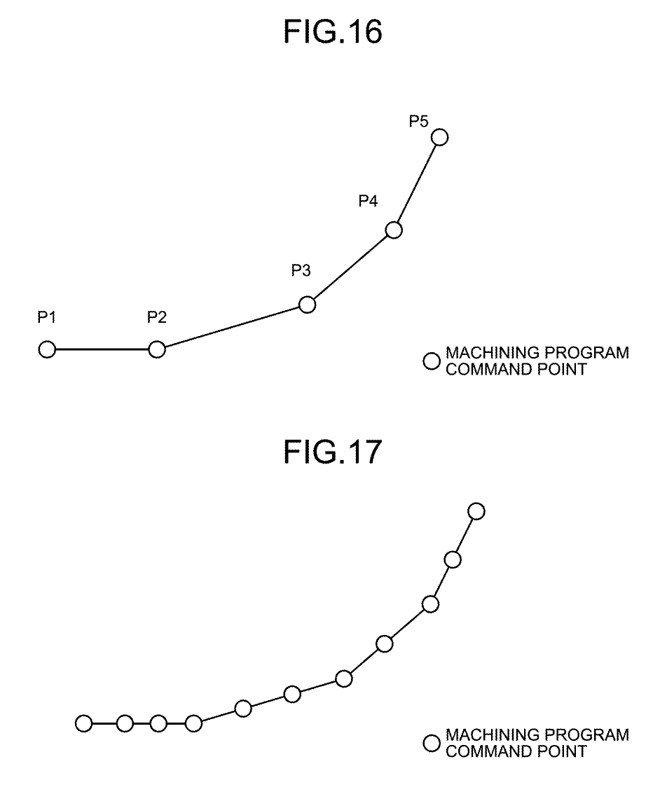

FIG. 16 is a diagram illustrating machining program command points for an arc shape according to the first embodiment. FIG. 17 is a diagram illustrating another set of machining program command points for an arc shape according to the first embodiment. FIGS. 16 and 17 illustrate the machining program command points on the command path of the same arc shape.

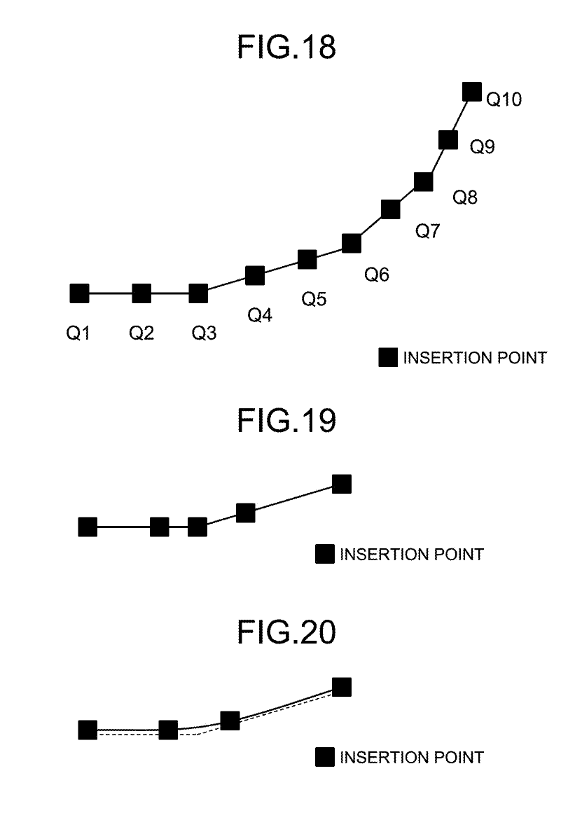

FIG. 18 is a diagram illustrating an example of insertion points generated for an arc shape according to the first embodiment. FIG. 18 illustrates the arrangement of insertion points Q1, Q2, . . . , Q9, and Q10 generated by the insertion point generating unit 14 on the command path of FIGS. 16 and 17 determined to have an arc shape. The insertion point generating unit 14 arranges the insertion points at regular intervals as illustrated in FIG. 18 when the program command shape determining unit 13 determines that the command path in accordance with instructions from the machining program 11 has an arc shape. As a result, the arc portion can be machined smoothly.

Note that the spacing between the insertion points arranged consecutively, such as the distance between the points Q2 and Q3 in FIG. 14, the distance between the points Q3 and Q4 in FIG. 14, and the regular interval in FIG. 18, is determined by the insertion point generating unit 14 such that the tool path generated by the interpolation unit 15 using the insertion points and an interpolation method to be described later falls within the tolerance set by the parameter setting unit 17 using the machining program command points.

The interpolation unit 15 receives information on the insertion point positioned by the insertion point generating unit 14 as an insertion point position 24, and it generates the tool path by performing interpolation on the basis of the insertion point. The interpolation unit 15 performs interpolation on the basis of the insertion point by linear approximating interpolation or curve approximating interpolation with respect to the insertion point. Here, NURBS curve approximation, Bezier curve approximation, B-spline curve approximation, or spline curve approximation can be used as the curve approximation.

FIG. 19 is a diagram illustrating how linear approximating interpolation is performed on the basis of the insertion points for the corner shape according to the first embodiment. A solid line in FIG. 19 indicates the tool path generated by the interpolation unit 15 using linear approximating interpolation with respect to the insertion points arranged as illustrated in FIG. 14. The tool path in this case overlaps with the command path before correction.

FIG. 20 is a diagram illustrating how curve approximating interpolation is performed on the basis of the insertion points for the corner shape according to the first embodiment. The solid line in FIG. 20 indicates the tool path generated by the interpolation unit 15 using curve approximating interpolation with respect to the insertion points arranged as illustrated in FIG. 15. The broken line indicates the command path before correction.

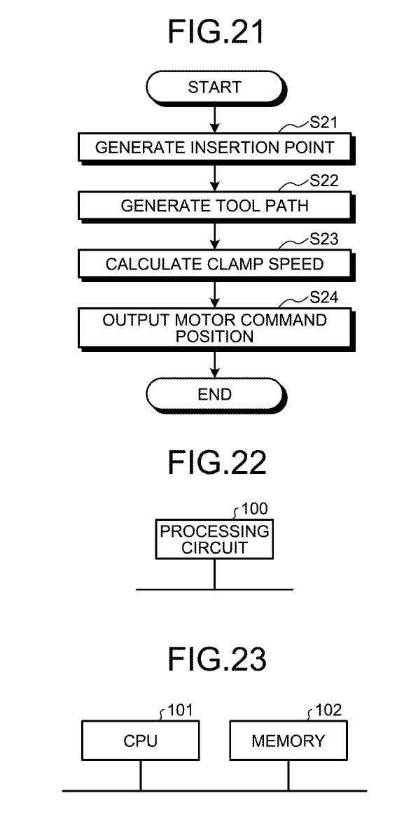

FIG. 21 is a flowchart illustrating a procedure starting from the generation of the insertion points and ending with the generation of a tool path according to the first embodiment.

First, the insertion point generating unit 14 generates an insertion point on the basis of the result of determination 23 and the machining program command position 22 (step S21). The interpolation unit 15 receives the insertion point position 24 and generates a tool path by performing interpolation using a predetermined interpolation method on the basis of the insertion point (step S22).

The interpolation unit 15 also calculates the clamp speed on the basis of the result of determination 23 (step S23). If the result of determination 23 indicates that “the command path has a corner shape”, the interpolation unit 15 calculates the allowable speed for a corner as the clamp speed. If the result of determination 23 indicates that “the command path has an arc shape”, the interpolation unit 15 calculates an arc clamp speed as the clamp speed.

Using the clamp speed obtained in step S23, the interpolation unit 15 calculates the travel of a tool for every interpolation cycle along the tool path generated in step S22, and it outputs the travel of a tool as the motor command position 25 to the motor control unit 16 (step S24).

FIG. 22 is a diagram illustrating an example in which a component of the numerical control apparatus 2 according to the first embodiment is implemented by dedicated hardware. In this case, each of the program command reading unit 12, the program command shape determining unit 13, the insertion point generating unit 14, the interpolation unit 15, and the parameter setting unit 17 included in the numerical control apparatus 2 includes a processing circuit 100 that is the dedicated hardware, as illustrated in FIG. 22. The processing circuit 100 corresponds to a single circuit, a complex circuit, a programmed processor, a parallel-programmed processor, an application specific integrated circuit (ASIC), a field programmable gate array (FPGA), or a combination of those. The functions of each of the program command reading unit 12, the program command shape determining unit 13, the insertion point generating unit 14, the interpolation unit 15, and the parameter setting unit 17 can be separately implemented by a plurality of the processing circuits 100, or can be collectively implemented by one processing circuit 100.

FIG. 23 is a diagram illustrating a hardware configuration when a component of the numerical control apparatus 2 according to the first embodiment is implemented by a computer. In this case, each of the program command reading unit 12, the program command shape determining unit 13, the insertion point generating unit 14, the interpolation unit 15, and the parameter setting unit 17 included in the numerical control apparatus 2 is implemented by a central processing unit (CPU) 101 and a memory 102 that are provided in the numerical control apparatus 2 and are as illustrated in FIG. 23, i.e., the function of the numerical control apparatus 2 is implemented by software, firmware, or a combination of software and firmware. The software or firmware is described as a program and stored in the memory 102. The program is a program different from the machining program 11. The CPU 101 implements the functions of the above components by reading and executing the program stored in the memory 102, i.e., the numerical control apparatus 2 includes the memory 102 for storing the above program by which a step implementing the operation of the above components is executed as a result when the computer executes the functions of the above components. The program can also be a program that causes the computer to execute the procedure or a method related to each of the program command reading unit 12, the program command shape determining unit 13, the insertion point generating unit 14, the interpolation unit 15, and the parameter setting unit 17.

Here, the memory 102 corresponds to a non-volatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disc, a mini disc, or a digital versatile disk (DVD).

Moreover, the functions of each of the program command reading unit 12, the program command shape determining unit 13, the insertion point generating unit 14, the interpolation unit 15, and the parameter setting unit 17 included in the numerical control apparatus 2 can be implemented partly by dedicated hardware and partly by software or firmware. The components of the numerical control apparatus 2 can thus implement the above functions thereof by hardware, software, firmware, or a combination of these.

As described above, the program command shape determining unit 13 according to the first embodiment determines the shape of the command path by calculating the angle formed by the command path and the index value I at each machining program command point on the basis of the information on the machining program command point that is included in the machining program command position 22. The insertion point generating unit 14 then generates the insertion point on the basis of the result of determination 23 of the shape, and the interpolation unit 15 generates the tool path by performing interpolation on the basis of the insertion point. The use of the index value I allows for arrangement of the insertion point corresponding to the shape of the command path; therefore, the tool path can be reliably generated even when the machining program 11 includes a gap such as a noise block due to the use of CAM. As a result, smooth machining can be performed with high accuracy regardless of the shape, such as a corner portion or an arc portion, whereby high-quality machining can be performed.

The configuration illustrated in the above embodiment merely illustrates an example of the present invention and can thus be combined with another known technique or partially omitted and/or modified without departing from the scope of the present invention.

### REFERENCE SIGNS LIST

1 NC machine tool; 2 numerical control apparatus; 11 machining program; 12 program command reading unit; 13 program command shape determining unit; insertion point generating unit; 15 interpolation unit; 16 motor control unit; 17 parameter setting unit; 22 machining program command position; 23 result of determination; 24 insertion point position; 25 motor command position; 100 processing circuit; 101 CPU; 102 memory.

1-6. (canceled)

7. A numerical control apparatus comprising:
program command shape determining circuitry to determine a type of shape of a command path formed by command points on the basis of information on the command points included in a machining program,
insertion point generating circuitry to generate insertion points on the basis of a result of determination by the program command shape determining circuitry and the information on the command points; and
interpolation circuitry
to generate a tool path of a tool by performing interpolation on the basis of the insertion points and
to output a motor command position on the basis of the tool path.

8. The numerical control apparatus according to claim 7, wherein
the type of shape includes a corner shape and an arc shape.

9. The numerical control apparatus according to claim 7, wherein the program command shape determining circuitry:
calculates a numerical value for each of the command points on the basis of the information on a plurality of the command points and
determines the type of the shape of the command path on the basis of a change in the numerical value calculated for each of the command points.

10. The numerical control apparatus according to claim 9, wherein:
the numerical value calculated for each of the command points is a change in ratio of each axis driven by a motor.

11. The numerical control apparatus according to claim 9, wherein
the insertion point generating circuitry generates the insertion points at two positions that are equidistant from the command point for which the change is calculated in a case where the result of determination is a corner shape.

12. The numerical control apparatus according to claim 7, wherein:
the insertion point generating circuitry generates the insertion points at regular intervals in a case where the result of determination is an arc shape.

13. The numerical control apparatus according to claim 7, wherein the interpolation circuitry:
calculates a clamp speed on the basis of the result of determination,
calculates a travel of the tool for every interpolation cycle along the tool path on the basis of the clamp speed, and
outputs the travel of a tool as the motor command position n to the motor control circuitry that controls a motor.
